(19) United States
(12) Patent Application Publication
(10) Pub. No.: US 2023/0351628 A1
(43) Pub. Date: Nov. 2, 2023

(54) DATA PROCESSING APPARATUS

(71) Applicant: SUBARU CORPORATION, Tokyo (JP)

(72) Inventors: Hiroaki KURAMOCHI, Tokyo (JP); Tetsuo SHIRAISHI, Tokyo (JP)

(73) Assignee: SUBARU CORPORATION, Tokyo (JP)

(21) Appl. No.: 18/124,428

(22) Filed: Mar. 21, 2023

(30) Foreign Application Priority Data
Mar. 31, 2022 (JP) 2022-059624

(51) Int. Cl. G06T 7/70; G06T 7/593

(52) U.S. Cl. CPC G06T 7/70; G06T 7/593; G06T 2207/10012; G06T 2207/10028; G06T 2207/30252

(57) ABSTRACT

A data processing apparatus to be applied to a vehicle includes a detector, a determiner, a processor, and an estimator. The detector detects first distance data on a first distance to a first target based on a distance image. The determiner determines, based on vehicle position data on a position of the vehicle and the first distance data, whether map data includes an object corresponding to the first target. The processor calculates second distance data on a second distance between the first target and a second target having a predetermined relationship with the first target based on the map data when the determiner determines that the map data includes the object corresponding to the first target. The estimator estimates position data of the second target based on the first distance data and the second distance data.

### CROSS-REFERENCE TO RELATED APPLICATION

The present application claims priority from Japanese Patent Application No. 2022-059624 filed on Mar. 31, 2022, the entire contents of which are hereby incorporated by reference.

### BACKGROUND

The disclosure relates to a data processing apparatus to be mounted on a vehicle.

A known technique is to image a region ahead of a vehicle by using a camera and sense a target on the basis of a resultant image. For example, references are made to Japanese Unexamined Patent Application Publication (JP-A) No. 2021-068317, JP-A No. 2013-184664, and JP-A No. 2021-033772.

### SUMMARY

An aspect of the disclosure provides a data processing apparatus to be applied to a vehicle includes a detector, a determiner, a processor, and an estimator. The detector is configured to detect, as first distance data, data on a first distance to a first target based on a distance image generated based on stereo images. The determiner is configured to determine, based on vehicle position data and the first distance data, whether map data includes an object corresponding to the first target. The vehicle position data is data on a position of the vehicle and acquired through communication with outside. The first distance data is detected by the detector. The processor is configured to calculate, as second distance data, data on a second distance between the first target and a second target based on the map data when the determiner determines that the map data includes the object corresponding to the first target. The second target has a predetermined relationship with the first target. The estimator is configured to estimate position data of the second target based on the first distance data detected by the detector and the second distance data calculated by the processor.

An aspect of the disclosure provides a data processing apparatus to be applied to a vehicle includes circuitry configured to: detect, as first distance data, data on a first distance to a first target based on a distance image generated based on stereo images; determine, based on vehicle position data and the detected first distance data, whether map data comprises an object corresponding to the first target; upon determining the map data comprises the object corresponding to the first target, calculate, as second distance data, data on a second distance between the first target and a second target based on the map data; and estimate position data of the second target based on he detected first distance data and the calculated second distance data. The vehicle position data is data on a position of the vehicle and acquired through communication with outside. The second target has a predetermined relationship with the first target.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a schematic configuration example of a traveling control system according to one example embodiment of the disclosure.

FIG. 2 is a diagram illustrating an example block of the traveling control system in FIG. 1.

FIG. 3 is a diagram for describing estimation of a position of a stop line.

FIG. 4 is a diagram for describing the estimation of the position of the stop line.

FIG. 5 is a diagram illustrating an example procedure of estimating the position of the stop line.

FIG. 6 is a diagram for describing the estimation of the position of the stop line in presence of multiple stop lines ahead of a vehicle.

FIG. 7 is a diagram for describing the estimation of the position of the stop line in presence of multiple traveling lanes.

### DETAILED DESCRIPTION

For example, in a case where a target is an object drawn on a road surface such as a stop line, the target is made unclear over time, hidden behind something, or covered with snow in some cases. In this case, it is difficult for a camera to sense the target. This makes it difficult to perform a process based on position data of the target in a case where the camera fails to detect the target.

It is desirable to provide a data processing apparatus that makes it possible to perform a process based on position data of a target even in a case where a camera fails to detect the target.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

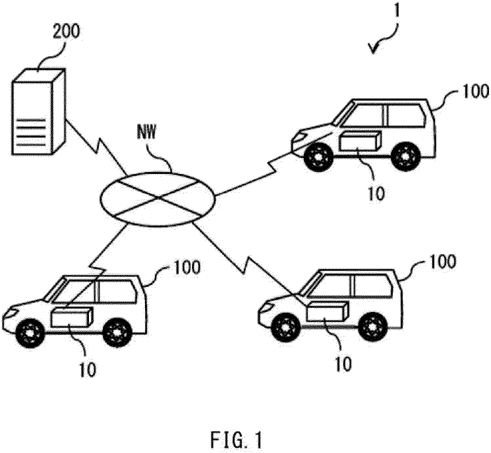

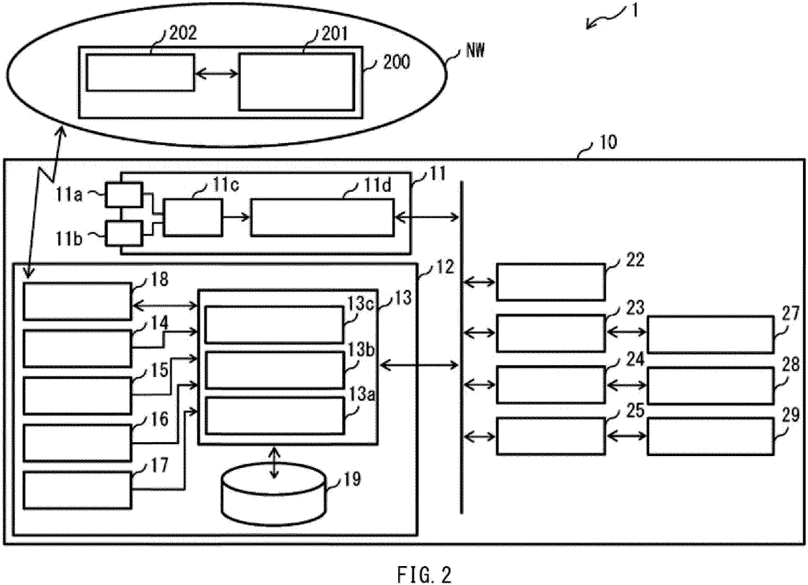

Each of FIGS. 1 and 2 illustrates a schematic configuration example of a traveling control system 1 according to an example embodiment of the disclosure. For example, as illustrated in FIGS. 1 and 2, the traveling control system 1 may include traveling control apparatuses 10 and a traffic control apparatus 200. The traveling control apparatuses 10 may be mounted on respective vehicles 100. The traffic control apparatus 200 may be provided in a network environment NW. The traveling control apparatuses 10 may be coupled to the network environment NW through wireless communication. The vehicles 100 may also be each referred to as the own vehicle 100. In one embodiment, the traveling control apparatuses 10 may each serve as a “data processing apparatus”.

The traffic control apparatus 200 may consecutively integrate and update pieces of road map data transmitted from the traveling control apparatuses 10 of the respective vehicles 100. The traffic control apparatus 200 may transmit the updated road map data to each of the vehicles 100. The traffic control apparatus 200 may include, for example, road map data integration ECU 201 and a transceiver 202.

The road map data integration ECU 201 may integrate the pieces of road map data collected from the respective vehicles 100 through the transceiver 202 to consecutively update the pieces of road map data on the surroundings of the vehicles 100 on roads. For example, the pieces of road map data may each include a dynamic map. The dynamic map may include static data, quasi-static data, quasi-dynamic data, and dynamic data. The static data and the quasi-static data may be included in road data. The quasi-dynamic data and the dynamic data may be included in traffic data.

The static data may include data to be updated every month or more frequently. Examples of such data may include data on roads and structures on roads, data on lanes, data on road surfaces, and data on permanent traffic regulations. Examples of the structures included in the static data may include traffic lights, intersections, road signs, and stop lines. In the static data, for example, structures that are highly related to each other may be further associated with each other. For example, a certain intersection, and a traffic light, a road sign, and a stop line provided along with the intersection may be associated with each other. In a case where a road includes multiple lanes, a stop line may be associated with each of the lanes in some cases. Each of the structures included in the static data may be provided with position coordinates in the dynamic map. In one embodiment, the position coordinates may serve as “position data”.

The quasi-static data may include data to be updated every hour or more frequently. Examples of such data may include data on traffic regulations caused by road constructions or events, data on wide-area weather, and data on traffic congestion prediction. The quasi-dynamic data may include data to be updated every minute or more frequently. Examples of such data may include data on temporary traffic obstruction caused by actual traffic congestion, traveling regulations, fallen objects, or obstacles at the time of observation, data on actual incidents, and data on narrow-area weather.

The dynamic data may include data to be updated by the second. Examples of such data may include data to be transmitted and exchanged between mobile bodies, data on the current indication of traffic lights, data on pedestrians and bicycles at intersections, and data on vehicles going straight through intersections.

The road map data integration ECU 201 may maintain or update such road map data until or before receiving the next road map data from each vehicle 100. The road map data integration ECU 201 may transmit the updated road map data as appropriate to the vehicle 100 through the transceiver 202.

The traveling control apparatus 10 may include a traveling environment recognition unit 11 and a locator unit 12 as units that recognize a traveling environment around the vehicle 100. The traveling control apparatus 10 may further include a traveling control unit (hereinafter referred to as traveling ECU) 22, an engine control unit (hereinafter referred to as E/G ECU) 23, a power steering control unit (hereinafter referred to as PS ECU) 24, and a brake control unit (hereinafter referred to as BK ECU) 25. These control units 22, 23, 24, and 25 may be coupled to the traveling environment recognition unit 11 and the locator unit 12 through in-vehicle communication lines such as a controller area network (CAN).

The traveling ECU 22 may control the vehicle 100, for example, in accordance with a driving mode. The driving mode may include, for example, a manual driving mode and a traveling control mode. The manual driving mode may be a driving mode in which a driver who drives the vehicle 100 keeps steering the vehicle 100. For example, in the manual driving mode, the own vehicle 100 may be caused to travel in accordance with the driver’s driving operation including a steering operation, an accelerator operation, and a brake operation. The traveling control mode may be a driving mode that supports a driver in a driving operation, for example, to increase the safety of a pedestrian or a vehicle around the own vehicle 100. The traveling ECU 22 may control the own vehicle 100 in the traveling control mode to cause the own vehicle 100 to stop at a stop line near an intersection, for example, in a case where the own vehicle 100 comes closer to the intersection and the traffic light provided at the intersection turns yellow from green and then turns red. Detailed processing contents in the traveling control mode are described in detail below. In one embodiment, the traveling ECU 22 may serve as a “determiner”, a “processor”, and an “estimator” .

The E/G ECU 23 may have an output terminal coupled to a throttle actuator 27. This throttle actuator 27 may open and close the throttle valve of the electronically controlled throttle provided in the throttle body of the engine. The throttle actuator 27 may open and close the throttle valve in accordance with a drive signal from the E/G ECU 23 to regulate an intake air flow rate, thereby generating a desired engine output.

The PS ECU 24 may have an output terminal coupled to an electric power steering motor 28. This electric power steering motor 28 may impart steering torque to the steering mechanism by using the rotatory force of a motor. In automatic driving, the electric power steering motor 28 may be controlled and operated in accordance with a drive signal from the PS ECU 24 to execute active lane keep centering control and lane change control. The active lane keep centering control may keep the own vehicle 100 traveling in the current traveling lane. The lane change control may move the own vehicle 100 to an adjacent lane, for example, for overtaking control.

The BK ECU 25 may have an output terminal coupled to a brake actuator 29. This brake actuator 29 may regulate the brake hydraulic pressure to be supplied to the brake wheel cylinder provided in each of the wheels. In a case where the brake actuator 29 is driven in accordance with a drive signal from the BK ECU 25, the brake wheel cylinder may generate brake force for the wheel and forcibly decelerate the own vehicle 100.

The traveling environment recognition unit 11 may be fixed, for example, at the upper central position in the front interior part of the vehicle 100. This traveling environment recognition unit 11 may include an onboard stereo camera, an image processing unit (IPU) 11c, and a traveling environment detector 11d. The onboard stereo camera may include a main camera 11a and a sub-camera 11b.

The main camera 11a and the sub-camera 11b may be autonomous sensors that each sense a real space around the vehicle 100. The main camera 11a and the sub-camera 11b may be disposed, for example, at respective positions bilaterally symmetrical about the middle of the vehicle 100 in the width direction. The main camera 11a and the sub-camera 11b may stereoscopically image a region ahead of the vehicle 100 from different viewpoints.

The IPU 11c generates a distance image on the basis of a pair of stereo images of the region ahead of the vehicle 100 captured by the main camera 11a and the sub-camera 11b. The distance image may be obtained from the amount of deviation between the corresponding positions of the target.

The traveling environment detector 11d may detect a lane line that defines a road around the vehicle 100, for example, on the basis of the distance image received from the IPU 11c. The traveling environment detector 11d may further calculate, for example, the road curvatures [⅟m] of the respective lane lines that define the left and right sides of the traveling lane in which the vehicle 100 is traveling and the width between the left and right lane lines. This width may correspond to the vehicle width. The traveling environment detector 11d may further perform, for example, predetermined pattern matching on the distance image to detect a lane or a three-dimensional object such as a structure around the vehicle 100.

In a case where the traveling environment detector 11d detects a three-dimensional object, the traveling environment detector 11d may detect, for example, the type of the three-dimensional object, the distance to the three-dimensional object, a speed of the three-dimensional object, and a relative speed between the three-dimensional object and the own vehicle 100. Examples of three-dimensional objects to be detected may include traffic lights, intersections, road signs, stop lines, other vehicles, and pedestrians. In one embodiment, the three-dimensional object may serve as a “first target”. In one embodiment, in a case where the three-dimensional object serves as the “first target”, data on the distance to the three-dimensional object may serve as “first distance data”. In one embodiment, the traveling environment detector 11d may serve as a “detector”. The traveling environment detector 11d may output, for example, the detected pieces of data on the three-dimensional object to the traveling ECU 22.

The locator unit 12 may estimate the position of the vehicle 100 on a road map. The position of the vehicle 100 may be referred to as an own vehicle position below. The locator unit 12 may include a locator processor 13 that estimates the own vehicle position. This locator processor 13 may have an input terminal coupled to sensors to be used to estimate the own vehicle position. Examples of such sensors may include an acceleration sensor 14, a vehicle speed sensor 15, a gyroscope sensor 16, and a GNSS receiver 17. The acceleration sensor 14 may detect a longitudinal acceleration of the vehicle 100. The vehicle speed sensor 15 may detect a speed of the vehicle 100. The gyroscope sensor 16 may detect an angular velocity or an angular acceleration of the vehicle 100. The GNSS receiver 17 may receive positioning signals emitted from positioning satellites. The locator processor 13 may be coupled to a transceiver 18. The transceiver 18 may transmit and receive data to and from the traffic control apparatus 200. In addition, the transceiver 18 may transmit and receive data to and from another vehicle 100.

The locator processor 13 may also be coupled to a high-precision road map database 19. The high-precision road map database 19 may be a mass storage medium such as HDD. The high-precision road map database 19 may store high-precision road map data. The high-precision road map data may also be referred to as the dynamic map. This high-precision road map data may include, for example, static data, quasi-static data, quasi-dynamic data, and dynamic data as with the road map data included in the road map data integration ECU 201. The static data and the quasi-static data may be included in the road data. The quasi-dynamic data and the dynamic data may be included in the traffic data.

The locator processor 13 may include, for example, a map data acquisition part 13a, a vehicle position estimation part 13b, and a traveling environment recognition part 13c.

The vehicle position estimation part 13b may acquire position coordinates of the own vehicle 100 on the basis of positioning signals received by the GNSS receiver 17. In one embodiment, the position coordinates may serve as “vehicle position data acquired through communication with outside”. The vehicle position estimation part 13b may match the acquired position coordinates to route map data to estimate the own vehicle position on the road map. The map data acquisition part 13a may acquire map data on a predetermined area from the map data stored in the high-precision road map database 19 on the basis of the position coordinates of the own vehicle 100 acquired by the vehicle position estimation part 13b. The predetermined area may include the own vehicle 100.

In an environment in which the vehicle position estimation part 13b fails to receive valid positioning signals from the positioning satellites because of a decrease in sensitivity of the GNSS receiver 17 in the vehicle 100 traveling, for example, in a tunnel, the vehicle position estimation part 13b may switch on autonomous navigation to estimate the own vehicle position on the road map. In the autonomous navigation, the vehicle position estimation part 13b may estimate the own vehicle position on the basis of the vehicle speed detected by the vehicle speed sensor 15, the angular velocity detected by the gyroscope sensor 16, and the longitudinal acceleration detected by the acceleration sensor 14.

The vehicle position estimation part 13b may estimate the own vehicle position on the road map on the basis of the positioning signals received by the GNSS receiver 17 or data detected by the gyroscope sensor 16 or another sensor. The vehicle position estimation part 13b may then determine, for example, a road type of a traveling lane in which the own vehicle 100 is traveling on the basis of the estimated own vehicle position on the road map.

The traveling environment recognition part 13c may replace the road map data stored in the high-precision road map database 19 with a latest version by using road map data acquired through external communication established through the transceiver 18. Examples of the external communication may include road-to-vehicle communication and vehicle-to-vehicle communication. The quasi-static data, the quasi-dynamic data, and the dynamic data may also be updated in addition to the static data. The road map data may thus include road data and traffic data acquired through the communication with the outside. Pieces of data on mobile bodies such as the vehicles 100 traveling on roads may be updated substantially in real time.

The traveling environment recognition part 13c may verify the road map data on the basis of data on the traveling environment recognized by the traveling environment recognition unit 11. The traveling environment recognition part 13c may replace the road map data stored in the high-precision road map database 19 with the latest version. The quasi-static data, the quasi-dynamic data, and the dynamic data may also be updated in addition to the static data. This may update, in real time, the pieces of data recognized by the traveling environment recognition unit 11 on mobile bodies such as the vehicles 100 traveling on roads.

The traveling environment recognition part 13c may then transmit the pieces of respective road map data updated in this way, for example, to the traffic control apparatus 200 and other vehicles around the own vehicle 100 through the road-to-vehicle communication and the vehicle-to-vehicle communication established through the transceiver 18.

The traveling environment recognition part 13c may further output the map data on the predetermined area in the updated road map data to the traveling ECU 22 along with the own vehicle position (vehicle position data). The predetermined area may include the own vehicle position estimated by the vehicle position estimation part 13b.

Next, the traveling ECU 22 is described in detail.

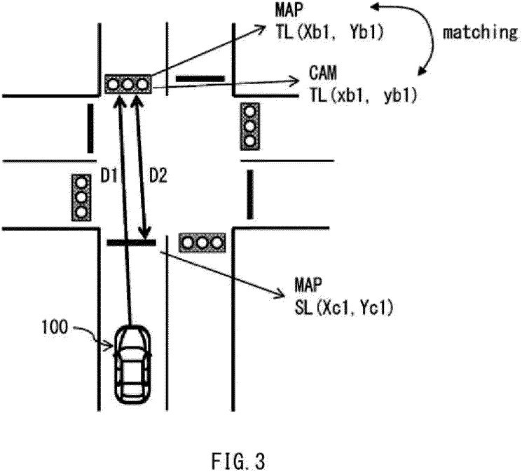

FIG. 3 is a diagram for describing estimation of a position of the stop line SL. FIG. 3 illustrates an example situation of the road ahead of the own vehicle 100. This example situation includes the own vehicle 100. In FIG. 3, the own vehicle 100 may include the traveling control apparatus 10. The own vehicle 100 may be traveling on a road with one lane on each side. The own vehicle 100 may have an intersection ahead. The intersection may include traffic lights and stop lines. In FIG. 3, “CAM” may indicate that position data described adjacent to CAM is position data obtained on the basis of image data obtained from the stereo camera. In FIG. 3, “MAP” may indicate that position data described adjacent to MAP is position data included in the road map data stored in the high-precision road map database 19.

The stereo camera included in the own vehicle 100 may image the region ahead of the own vehicle 100. The stereo camera may output resultant stereo images to the IPU 11c. The stereo images may each include at least an intersection, a traffic light TL, and a stop line SL. The traffic light TL and the stop line SL may be provided in association with the intersection. In one embodiment, the traffic light TL may serve as the “first target”. In one embodiment, the stop line SL may serve as a “second target”. The traffic light TL may be a target that is relatively easier for the stereo camera to image than the stop line SL. The stop line SL may be a target that is relatively more difficult for the stereo camera to image than the traffic light TL.

In a case of a road including a visually recognizable stop line as illustrated in FIG. 3, it may be highly possible that a stop line included in each of the stereo images is also visually recognizable. In this case, the traveling environment detector 11d makes it possible to directly detect the stop line. The traveling ECU 22 may then acquire a position (Xc1, Yc1) of the stop line SL on the basis of a distance to the stop line SL, the map data, and the own vehicle position (vehicle position data). The distance to the stop line SL may be detected by the traveling environment detector 11d. The map data and the vehicle position data may be acquired from the traveling environment recognition part 13c. Of the position (Xc1, Yc1), Xc1 may be longitude data in the road map data stored in the high-precision road map database 19. Of the position (Xc1, Yc1), Yc1 may be latitude data in the road map data stored in the high-precision road map database 19.

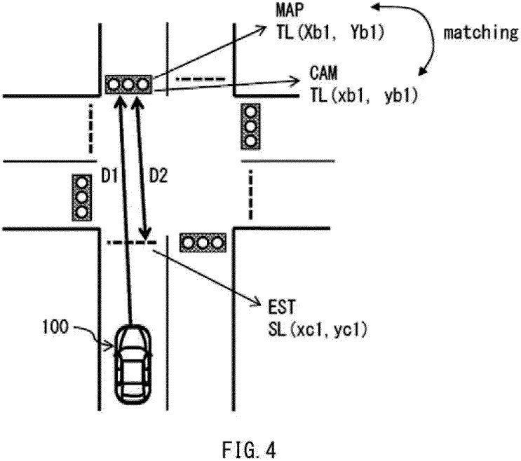

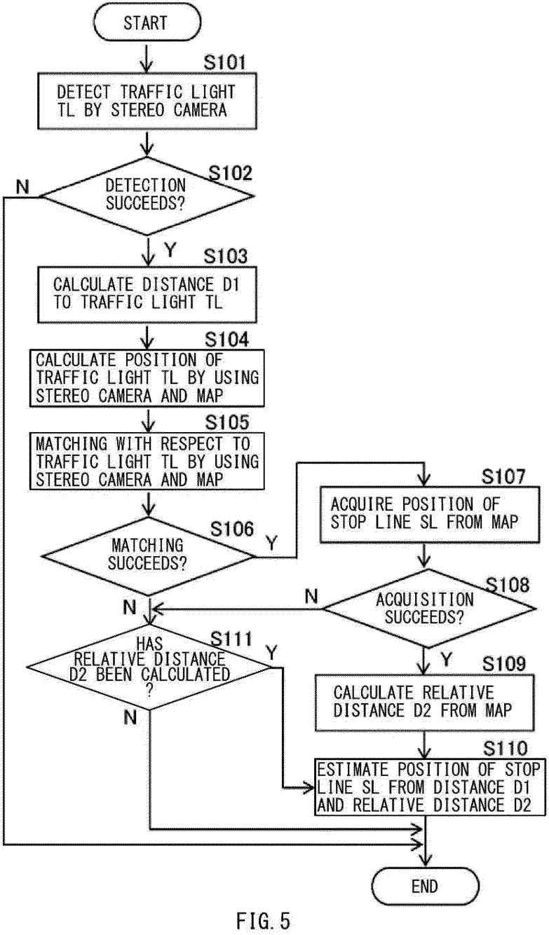

It may be, however, highly possible that the traveling environment detector 11d fails to detect the stop line SL in each stereo image, for example, in a case of a road including the visually unrecognizable stop line SL as illustrated in FIG. 4. The traveling ECU 22 makes it possible to estimate the position of the stop line SL in preparation for such a situation even in a case where the traveling ECU 22 acquires no data on the stop line SL from the traveling environment detector 11d. In FIG. 4, “EST” may indicate that position data described adjacent to EST is position data estimated by using data different from position data in the road map data stored in the high-precision road map database 19. The following describes a procedure of estimating the position of the stop line SL by the traveling ECU 22 with reference to FIG. 5.

FIG. 5 illustrates an example procedure of estimating the position of the stop line SL. First, the stereo camera may acquire stereo images. The stereo camera may output the stereo images to the IPU 11c. The IPU 11c generates a distance image on the basis of the stereo images acquired by the stereo camera. The IPU 11c may output the distance image to the traveling environment detector 11d. The traveling environment detector 11d may detect, in Step S101, the traffic light TL by performing, for example, predetermined pattern matching on the distance image generated by the IPU 11c. It is to be noted that the traveling environment detector 11d may also detect the traffic light TL by performing the predetermined pattern matching on one or both of the distance image and the stereo images.

In a case where the traveling environment detector 11d succeeds in detecting the traffic light TL in Step S101 (Step S102: Y), the traveling environment detector 11d may calculate a distance D1 from the own vehicle 100 to the traffic light TL in Step S103. The traveling environment detector 11d may calculate the distance D1, for example, on the basis of the distance image. The traveling environment detector 11d may output the distance D1 to the traveling ECU 22 in association with an identifier of the traffic light TL.

The traveling ECU 22 may acquire the map data on the predetermined area and the own vehicle position (vehicle position data) from the traveling environment recognition part 13c. The predetermined area may include the own vehicle position. The own vehicle position may be estimated by the vehicle position estimation part 13b. The traveling ECU 22 may perform matching in Step S105 with respect to the traffic light TL on the basis of the distance D1, the identifier of the traffic light TL, the map data, and the own vehicle position (vehicle position data). The distance D1 and the identifier of the traffic light TL may be acquired from the traveling environment detector 11d. The map data and the own vehicle position (vehicle position data) may be acquired from the traveling environment recognition part 13c.

In one example, the traveling ECU 22 determines whether the map data acquired from the traveling environment recognition part 13c includes an object corresponding to the traffic light TL detected by the traveling environment recognition part 13c. For example, the traveling ECU 22 may acquire a position (xbl, yb1) from the map data acquired from the traveling environment recognition part 13c as a position of the traffic light TL acquired by the stereo camera. The position (xbl, yb1) may be away from the own vehicle position (vehicle position data) by the distance D1. Of the position (xbl, yb1), xb1 may be the longitude data in the road map data stored in the high-precision road map database 19. Of the position (xbl, yb1), yb1 may be the latitude data in the road map data stored in the high-precision road map database 19.

Thereafter, the traveling ECU 22 may determine whether an area having a predetermined distance from the position (xbl, yb1) of the traffic light TL in the map data includes the object corresponding to the traffic light TL. The map data may be acquired from the traveling environment recognition part 13c. In one embodiment, the predetermined distance may serve as a “predetermined threshold”. For example, in a case where the traveling ECU 22 detects the traffic light TL at a position (Xb1, Yb1) within the area having the predetermined distance from the position (xb1, yb1) of the traffic light TL in the map data acquired from the traveling environment recognition part 13c, the traveling ECU 22 may acquire the position (Xb1, Yb1) as the position of the traffic light TL in the map data acquired from the traveling environment recognition part 13c. Of the position (Xb1, Yb1), Xb1 may be the longitude data in the road map data stored in the high-precision road map database 19. Of the position (Xb1, Yb1), Yb1 may be the latitude data in the road map data stored in the high-precision road map database 19.

The traveling ECU 22 may set a constant value as the “predetermined distance” to be used for the determination regardless of the length of the distance D1 acquired from the traveling environment detector 11d. The traveling ECU 22 may decrease the “predetermined distance” to be used for the determination as the distance D1 acquired from the traveling environment detector 11d decreases over time. The traveling ECU 22 may continuously or smoothly decrease a value of the “predetermined distance” to be used for the determination as the distance D1 decreases. The traveling ECU 22 may intermittently or gradually decrease the value of the “predetermined distance” to be used for the determination as the distance D1 decreases. To perform more accurate matching as the own vehicle 100 comes closer to the traffic light TL, the “predetermined distance” may be changed in this way.

In a case where the matching succeeds with respect to the traffic light TL (Step S106: Y), the traveling ECU 22 may acquire, in Step S107, the position data (Xc1, Yc1) of the stop line SL corresponding to the traffic light TL at the position (Xb1, Yb1) from the map data acquired from the traveling environment recognition part 13c. In a case where the traveling ECU 22 succeeds in acquiring the position (Xc1, Yc1) of the stop line SL corresponding to the traffic light TL at the position (Xb1, Yb1) (Step S108: Y), the traveling ECU 22 calculates, in Step S109, a relative distance D2 between the traffic light TL and the stop line SL on the basis of the map data acquired from the traveling environment recognition part 13c. In one embodiment, data on the relative distance D2 may serve as “second distance data”. In one example, the traveling ECU 22 may calculate the relative distance D2 by using the position (Xb1, Yb1) of the traffic light TL and the position (Xc1, Yc1) of the stop line SL.

The traveling ECU 22 may estimate a position (xc1, yc1) of the stop line SL in Step S110 by using the own vehicle position (vehicle position data), the distance D1, and the relative distance D2. In the case of the road including the visually unrecognizable stop line SL as illustrated in FIG. 4, it may be highly possible that the traveling ECU 22 fails to acquire the position (Xc1, Yc1)of the stop line SL. In other words, in a case of a road in which the traveling environment detector 11d fails to detect the stop line SL from the image data obtained by the stereo camera, it may be highly possible that the traveling ECU 22 fails to acquire the position (Xc1, Yc1)of the stop line SL. In such a case, the traveling ECU 22 may use the position (xc1, yc1) obtained through the estimation as the position data of the stop line SL.

In contrast, in a case where the matching does not succeed with respect to the traffic light TL (Step S106: N) or in a case where the traveling ECU 22 fails to acquire the position (Xc1, Yc1)of the stop line SL corresponding to the traffic light TL at the position (Xb1, Yb1) (Step S108: N), the traveling ECU 22 may determine, in Step S111, whether the relative distance D2 has been calculated in the past. In a case where a result of the determination indicates that the relative distance D2 has been calculated in the past (Step S111: Y), the traveling ECU 22 may estimate the position (xc1, yc1) of the stop line SL in Step S110 by using the relative distance D2 calculated in the past, the own vehicle position (vehicle position data), and the distance D1. In contrast, in a case where the result of the determination indicates that the relative distance D2 has not been calculated in the past (Step S111: N), the traveling ECU 22 may finish estimating the position of the stop line SL.

Next, example effects of the traveling control system 1 according to the example embodiment of the disclosure are described.

In the example embodiment, the traveling ECU 22 determines, on the basis of the position coordinates of the own vehicle 100 and the distance D1 to the traffic light TL, whether the map data includes the object corresponding to the traffic light TL. The distance D1 may be obtained from the distance image generated on the basis of the stereo images. In a case where the traveling ECU 22 determines that the map data includes the object corresponding to the traffic light TL, the traveling ECU 22 calculates the relative distance D2 between the traffic light TL and the stop line SL having a predetermined relationship with the traffic light TL on the basis of the map data. The traveling ECU 22 estimates the position data of the stop line SL on the basis of the distance D1 and the relative distance D2. In the example embodiment, the traveling ECU 22 may not calculate the position of the stop line SL on the basis of the stereo images. The traveling ECU 22 may, however, calculate the position of the stop line SL by using the relative distance D2 calculated on the basis of the map data. This makes it possible to estimate and obtain the position of the stop line SL even in failing to detect the position of the stop line SL on the basis of the stereo images. As a result, it is possible to perform a process based on the position data of the stop line SL.

In the example embodiment, the traffic light TL and the stop line SL may be associated with each other in the map data. This allows the driver to know the position of the stop line SL corresponding to the detected traffic light TL by simply referring to the map data. It is thus possible to estimate the position of the stop line SL with a smaller amount of calculation.

In the example embodiment, the traveling ECU 22 may determine whether the area having the predetermined distance from the position (xb1, yb1) of the traffic light TL in the map data includes the object corresponding to the traffic light TL. The map data may be acquired from the traveling environment recognition part 13c. The use of such a determination method allows the traffic light TL included in the map data to be detected while taking into consideration precision of the position (xbl, yb1) of the traffic light TL obtained from the stereo camera.

In the determination method according to the example embodiment, the predetermined distance may decrease as the distance D1 decreases. Changing the predetermined distance in this way makes it possible to detect the position of the traffic light TL on the map with higher precision as the own vehicle 100 comes closer to the traffic light TL.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

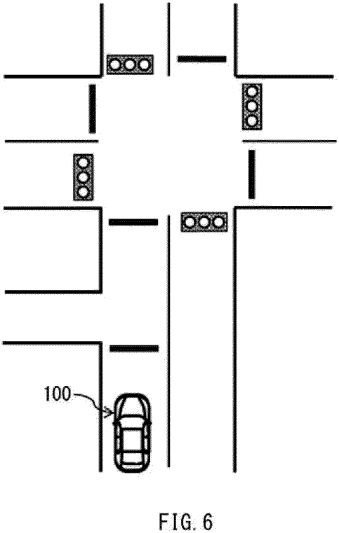

In the example embodiment, for example, the vehicle 100 may have multiple stop lines ahead as illustrated in FIG. 6. In this case, it may be possible that the traveling ECU 22 selects a relatively closer stop line as the stop line SL corresponding to the traffic light TL. The relatively closer stop line in the map data acquired from the traveling environment recognition part 13c may not be, however, associated as the stop line SL corresponding to the traffic light TL. This allows the traveling ECU 22 to correctly select a relatively farther stop line as the stop line SL corresponding to the traffic light TL instead of the relatively closer stop line by using data on correspondence between the stop line SL and the traffic light TL. The data on the correspondence may be included in the map data acquired from the traveling environment recognition part 13c.

It may be possible in the first place that the map data acquired from the traveling environment recognition part 13c does not define the stop line SL corresponding to the traffic light TL. Such a possibility may arise, for example, in a case where the map data does not include the data on the correspondence between the stop line SL and the traffic light TL because the traffic light TL is newly installed or moved. In a case where the traveling environment detector 11d detects multiple stop lines in front of the traffic light TL, the traveling ECU 22 may thus select, as the stop line SL corresponding to the traffic light TL, a stop line that is closest to the traffic light TL among the stop lines in front of the traffic light TL detected by the traveling environment detector 11d.

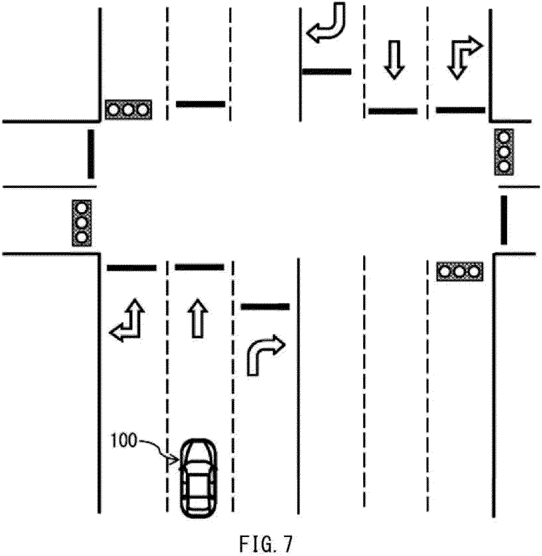

In the example embodiment and the modification example A, the own vehicle 100 may travel in one of traveling lanes, for example, as illustrated in FIG. 7. In this case, it may be possible that the traveling ECU 22 selects, as the stop line SL corresponding to the traffic light TL, a stop line of a traveling lane different from the traveling lane in which the own vehicle 100 is traveling. The traveling ECU 22 may thus use data on a traveling lane included in the correspondence between the stop line SL and the traffic light TL. This allows the traveling ECU 22 to correctly select the stop line SL corresponding to the traveling lane in which the own vehicle 100 is traveling. The data on the traveling lane may be included in the map data acquired from the traveling environment recognition part 13c.

It may be possible that the map data acquired from the traveling environment recognition part 13c defines, as the data on the stop line SL corresponding to the traffic light TL, only data on the stop line of the traveling lane different from the traveling lane in which the own vehicle 100 is traveling. In a case where the traveling environment detector 11d detects multiple traveling lanes, the traveling ECU 22 may thus estimate the position data of the stop line SL corresponding to the traveling lane in which the own vehicle 100 is traveling from the position data of the stop line SL corresponding to the traffic light TL on the basis of a position relationship between the traveling lane of the stop line SL corresponding to the traffic light TL and the traveling lane in which the own vehicle 100 is traveling.

In the example embodiment and the modification examples A and B, examples of targets that are relatively easy for the stereo camera to image may include traffic lights. Examples of targets that are relatively difficult for the stereo camera to image may include stop lines. In the example embodiment and the modification examples A and B, the targets that are relatively easy for the stereo camera to image may be, however, intersections and road signs. In the example embodiment and the modification examples A and B, the targets that are relatively easy for the stereo camera to image may also be targets other than stop lines.

The example embodiment and the modification examples A, B, and C may adopt two-dimensional position coordinates. Three-dimensional position coordinates may be, however, adopted.

In the example embodiment and the modification examples A, B, C, and D, traveling of the vehicle 100 may be controlled by using the position of the stop line SL. However, the position of the stop line SL may be used for other application in the example embodiment and the modification examples A, B, C, and D. For example, a stop line proximity region having the predetermined distance or a shorter distance from the position of the stop line SL at certain time and a region around the stop line proximity region may have respective different thresholds in each stereo image. This may facilitate the stop line SL to be detected on the basis of the stereo image afterwards.

The effects described herein are mere examples and non-limiting. Other effects may be achieved.

The traveling ECU 22 and the traveling environment detector 11d illustrated in FIG. 2 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the traveling ECU 22 and the traveling environment detector 11d. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the traveling ECU 22 and the traveling environment detector 11d illustrated in FIG. 2.

1. A data processing apparatus to be applied to a vehicle, the data processing apparatus comprising:
a detector configured to detect, as first distance data, data on a first distance to a first target based on a distance image generated based on stereo images;
a determiner configured to determine, based on vehicle position data and the first distance data, whether map data comprises an object corresponding to the first target, the vehicle position data being data on a position of the vehicle and acquired through communication with outside, the first distance data being detected by the detector;
a processor configured to calculate, as second distance data, data on a second distance between the first target and a second target based on the map data when the determiner determines that the map data comprises the object corresponding to the first target, the second target having a predetermined relationship with the first target; and
an estimator configured to estimate position data of the second target based on the first distance data detected by the detector and the second distance data calculated by the processor.

2. The data processing apparatus according to claim 1, wherein the processor is configured to estimate the position data of the second target based on the first distance data and the second distance data, the second distance data having been calculated in past.

3. The data processing apparatus according to claim 1, wherein the first target and the second target are associated with each other in the map data.

4. The data processing apparatus according to claim 2, wherein the first target and the second target are associated with each other in the map data.

5. The data processing apparatus according to claim 1, wherein
the first target comprises a target that is relatively easy for a stereo camera to image, and
the second target comprises a target that is relatively difficult for the stereo camera to image.

6. The data processing apparatus according to claim 2, wherein
the first target comprises a target that is relatively easy for a stereo camera to image, and
the second target comprises a target that is relatively difficult for the stereo camera to image.

7. The data processing apparatus according to claim 3, wherein
the first target comprises a target that is relatively easy for a stereo camera to image, and
the second target comprises a target that is relatively difficult for the stereo camera to image.

8. The data processing apparatus according to claim 4, wherein
the first target comprises a target that is relatively easy for a stereo camera to image, and
the second target comprises a target that is relatively difficult for the stereo camera to image.

9. The data processing apparatus according to claim 5, wherein
the first target comprises a traffic light, and
the second target comprises a stop line.

10. The data processing apparatus according to claim 6, wherein
the first target comprises a traffic light, and
the second target comprises a stop line.

11. The data processing apparatus according to claim 1, wherein the determiner is configured to determine whether an area having a predetermined threshold from a position of the first target in the map data comprises the object corresponding to the first target, the area being obtained from the vehicle position data and the first distance data.

12. The data processing apparatus according to claim 2, wherein the determiner is configured to determine whether an area having a predetermined threshold from a position of the first target in the map data comprises the object corresponding to the first target, the area being obtained from the vehicle position data and the first distance data.

13. The data processing apparatus according to claim 3, wherein the determiner is configured to determine whether an area having a predetermined threshold from a position of the first target in the map data comprises the object corresponding to the first target, the area being obtained from the vehicle position data and the first distance data.

14. The data processing apparatus according to claim 4, wherein the determiner is configured to determine whether an area having a predetermined threshold from a position of the first target in the map data comprises the object corresponding to the first target, the area being obtained from the vehicle position data and the first distance data.

15. The data processing apparatus according to claim 11, wherein the determiner is configured to decrease the predetermined threshold as the first distance data decreases in the first distance to the first target.

16. The data processing apparatus according to claim 12, wherein the determiner is configured to decrease the predetermined threshold as the first distance data decreases in the first distance to the first target.

17. A data processing apparatus to be applied to a vehicle, the data processing apparatus comprising
circuitry configured to
detect, as first distance data, data on a first distance to a first target based on a distance image generated based on stereo images,
determine, based on based on vehicle position data and the detected first distance data, whether map data comprises an object corresponding to the first target, the vehicle position data being data on a position of the vehicle and acquired through communication with outside,
upon determining the map data comprises the object corresponding to the first target, calculate, as second distance data, data on a second distance between the first target and a second target based on the map data when the second target having a predetermined relationship with the first target, and
estimate position data of the second target based on the detected first distance data and the calculated second distance data.
